(19) United States
(12) Patent Application Publication
(10) Pub. No.: US 2021/0048893 A1
(43) Pub. Date: Feb. 18, 2021

(54) DEVICE FOR INPUTTING CHINESE WORD BASED ON FIRST-INPUT CHINESE CHARACTER AND CONTROL METHOD THEREOF

(71) Applicant: BENEDEA INC., Seoul (KR)

(72) Inventors: Seung-Kwon NOH, Seoul (KR); Jin-Soo KIM, Seoul (KR); Hyun-Kyung NOH, Seoul (KR)

(21) Appl. No.: 16/679,648

(22) Filed: Nov. 11, 2019

(30) Foreign Application Priority Data
Aug. 13, 2019 (KR) 10-2019-0098865

(51) Int. Cl. G06F 3/01; G06F 3/0488; G06F 3/0482; G06F 17/27; G06F 3/023

(52) U.S. Cl. CPC G06F 3/018; G06F 3/04886; G06F 3/0237; G06F 17/276; G06F 3/0482

(57) ABSTRACT

There is provided a method for inputting a Chinese word based on a first-input Chinese character, the method comprising: receiving a first-input Chinese character of a first letter of a target word from a user; displaying at least some of recommended Chinese words on a word-recommending interface of a device, wherein each recommended Chinese word is composed of at least one letter and has a letter including the first-input Chinese character; and displaying a Chinese word selected from the recommended Chinese words by the user on a selected-word display interface of the device.

### CROSS-REFERENCE TO RELATED APPLICATION

This application claims a benefit under 35 U.S.C. § 119(a) of Korean Patent Application No. 10-2019-0098865 filed on Aug. 13, 2019, on the Korean Intellectual Property Office, the entire disclosure of which is incorporated herein by reference for all purposes.

### BACKGROUND

### 1. Field

The present disclosure relates to a device for inputting a Chinese word based on a first-input Chinese character and to a control method thereof.

### 2. Description of Related Art

With recent development of China, the number of people who need to use Chinese letters is increasing. The Chinese letter is an ideogram that includes hieroglyphs, unlike Korean or English characters which have a relatively simple letter system. The Chinese letters include tens of thousands of unstructured characters. However, electronic devices such as computers and mobile phones have a keyboard with a limited number of buttons as input means. Thus, it is not possible to input the Chinese letters themselves using the electronic devices.

Traditionally, a Chinese Pinyin based input method is most commonly used for inputting Chinese letters.

In the Chinese Pinyin based input method, when a user inputs a pronunciation of a Chinese letter using English alphabets, a display lists candidate Chinese letters of a pronunciation as expressed by the input English alphabet. Then, the user selects a character among them. However, even when the user knows a Chinese letter the user wants to input, the user needs to input the Chinese letter using the English alphabet. Further, there is a disadvantage that it is difficult for the user to input an exact Chinese letter when the user does not know an exact pronunciation thereof. Further, too many Chinese letters have the same pronunciation. Thus, every time the user input a letter, the user have to select a target character from a group of Chinese letters with the same pronunciation. Thus, it may be difficult for the user to input Chinese letters quickly.

Therefore, a method of directly inputting a Chinese letter unlike the Chinese Pinyin based input method is being researched.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a device for inputting a Chinese word based on a first-input Chinese character and a method for controlling the device in which a Chinese letter may be quickly input via input of a first-input Chinese character, a single-stroke Chinese character, and/or a multiple-strokes Chinese character instead of English alphabets.

As used herein, the single-stroke Chinese character means a Chinese character having a single-stroke. Further, the multiple-strokes Chinese character means a Chinese character having multiple-strokes. The first-input Chinese character means the single-stroke Chinese character or the multiple-strokes Chinese character as a topmost member or a topmost and leftmost member of a Chinese letter.

A purpose of the present disclosure is to provide a device for inputting a Chinese word based on a first-input Chinese character and a method for controlling the device in which a Chinese word may be quickly input via input of a first-input Chinese character, a single-stroke Chinese character, or a multiple-strokes Chinese character and an inter-letters spacer instead of English alphabets.

Purposes of the present disclosure are not limited to the above-mentioned purpose. Other purposes and advantages of the present disclosure as not mentioned above may be understood from following descriptions and more clearly understood from embodiments of the present disclosure. Further, it will be readily appreciated that the purposes and advantages of the present disclosure may be realized by features and combinations thereof as disclosed in the claims.

In a first aspect of the present disclosure, there is provided a method for inputting a Chinese word based on a first-input Chinese character, the method comprising: receiving a first-input Chinese character of a first letter of a target word from a user; displaying at least some of recommended Chinese words on a word-recommending interface of a device, wherein each recommended Chinese word is composed of at least one letter and has a letter including the first-input Chinese character; and displaying a Chinese word selected from the recommended Chinese words by the user on a selected-word display interface of the device.

In one implementation of the method, the method further comprises: receiving at least one single-stroke Chinese character or multiple-strokes Chinese character from the user after receiving the first-input Chinese character; and displaying at least some of recommended Chinese words on the word-recommending interface of a device, wherein each recommended Chinese word is composed of at least one letter and has a letter including the first-input Chinese character and the at least one single-stroke Chinese character or multiple-strokes Chinese character.

In one implementation of the method, the method further comprises: receiving an inter-letters spacer from the user after receiving the first-input Chinese character; and displaying at least some of recommended Chinese words on the word-recommending interface, wherein each recommended Chinese word is composed of at least two letters and has a letter including the first-input Chinese character.

In one implementation of the method, the method further comprises: receiving a first-input Chinese character of a second letter of the target word from the user after receiving the inter-letters spacer; and displaying at least some of recommended Chinese words on the word-recommending interface, wherein each recommended Chinese word is composed of at least two letters and has a letter including the first-input Chinese character of the first letter and the first-input Chinese character of the second letter.

In one implementation of the method, the first-input Chinese character includes: a single-stroke Chinese character as a topmost member or a topmost and leftmost member of the first letter of the target word; or one of all of multiple-strokes Chinese characters of the first letter of the target word.

In one implementation of the method, the at least one single-stroke Chinese character or multiple-strokes Chinese character includes at least two single-stroke Chinese character or multiple-strokes Chinese charters, wherein each of the recommended Chinese words has the at least two single-stroke Chinese character or multiple-strokes Chinese charters, wherein the recommended Chinese words are independent from a receiving sequence of the at least two single-stroke Chinese character or multiple-strokes Chinese charters.

In one implementation of the method, the method further comprises: activating an extending button of the device while the at least some of the recommended Chinese words are displayed on the word-recommending interface, such that a number of the recommended Chinese words displayed on the word-recommending interface is increased; or activating a reducing button of the device while the at least some of the recommended Chinese words are displayed on the word-recommending interface, such that a number of the recommended Chinese words displayed on the word-recommending interface is decreased.

In a second aspect of the present disclosure, there is provided a device for inputting a Chinese word based on a first-input Chinese character, the device comprising: an input interface configured to receive a first-input Chinese character of a first letter of a target word from a user; a controller configured to determine recommended Chinese words based on the first-input Chinese character such that each recommended Chinese word is composed of at least one letter and has a letter including the first-input Chinese character; and a display configured to display at least some of the recommended Chinese words on a word-recommending interface and to display a Chinese word selected from the recommended Chinese words by the user on a selected-word display interface.

In one implementation of the device, the input interface is further configured to receive at least one single-stroke Chinese character or multiple-strokes Chinese character from the user after receiving the first-input Chinese character, wherein the controller is further configured to determine the recommended Chinese words such that each recommended Chinese word is composed of at least one letter and has a letter including the first-input Chinese character and the at least one single-stroke Chinese character or multiple-strokes Chinese character, wherein the display is further configured to display at least some of the recommended Chinese words on the word-recommending interface.

In one implementation of the device, the input interface is further configured to receive an inter-letters spacer from the user after receiving the first-input Chinese character, wherein the controller is further configured to determine the recommended Chinese words such that each recommended Chinese word is composed of at least two letters and has a letter including the first-input Chinese character, wherein the display is further configured to display at least some of the recommended Chinese words on the word-recommending interface.

In one implementation of the device, the input interface is further configured to receive a first-input Chinese character of a second letter of the target word from the user after receiving the inter-letters spacer, wherein the controller is further configured to determine the recommended Chinese words such that each recommended Chinese word is composed of at least two letters and has a letter including the first-input Chinese character of the first letter and the first-input Chinese character of the second letter, wherein the display is further configured to display at least some of the recommended Chinese words on the word-recommending interface.

In one implementation of the device, the first-input Chinese character includes: a single-stroke Chinese character as a topmost member or a topmost and leftmost member of the first letter of the target word; or one of all of multiple-strokes Chinese characters of the first letter of the target word.

In one implementation of the device, the at least one single-stroke Chinese character or multiple-strokes Chinese character includes at least two single-stroke Chinese character or multiple-strokes Chinese charters, wherein each of the recommended Chinese words has the at least two single-stroke Chinese character or multiple-strokes Chinese charters, wherein the controller is further configured to determine the recommended Chinese words in an independent from a receiving sequence of the at least two single-stroke Chinese character or multiple-strokes Chinese charters.

In one implementation of the device, the controller is further configured to: activate an extending button of the device while the at least some of the recommended Chinese words are displayed on the word-recommending interface, such that a number of the recommended Chinese words displayed on the word-recommending interface is increased; or activate a reducing button of the device while the at least some of the recommended Chinese words are displayed on the word-recommending interface, such that a number of the recommended Chinese words displayed on the word-recommending interface is decreased.

Effects of the present disclosure are as follows but are not limited thereto.

When using a device for inputting a Chinese word based on a first-input Chinese character and a method for controlling the device in accordance with the present disclosure, a Chinese letter may be quickly input via input of a first-input Chinese character, a single-stroke Chinese character, and/or a multiple-strokes Chinese character instead of English alphabets.

Further, when using a device for inputting a Chinese word based on a first-input Chinese character and a method for controlling the device in accordance with the present disclosure, a Chinese word may be quickly input via input of a first-input Chinese character, a single-stroke Chinese character, or a multiple-strokes Chinese character and an inter-letters spacer instead of English alphabets.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram showing a schematic configuration of a device for inputting a Chinese word based on a first-input Chinese character according to an embodiment of the present disclosure.

FIG. 2 shows an example of a screen where a word-recommending interface is not extended when a device for inputting a Chinese word based on a first-input Chinese character according to the present disclosure is embodied as a smart phone.

FIG. 3 shows an example of a screen where a word-recommending interface has been extended when a device for inputting a Chinese word based on a first-input Chinese character according to the present disclosure is embodied as a smart phone.

FIG. 4 shows an example of a virtual keyboard having a single-stroke Chinese character button and a multiple-strokes Chinese character button according to the present disclosure.

FIG. 5 and FIG. 6 show an example of a screen that displays a process of inputting a word composed of one letter via inputting a first-input Chinese character of a first letter of the word and at least one single-stroke Chinese character or multiple-strokes Chinese character, when a device for inputting a Chinese word based on a first-input Chinese character according to the present disclosure is embodied as a smart phone.

FIG. 7 to FIG. 9 show an example of a screen that displays a process of inputting a word composed of two letters via inputting a first-input Chinese character of a first letter of the word, and an inter-letters spacer, when a device for inputting a Chinese word based on a first-input Chinese character according to the present disclosure is embodied as a smart phone.

FIG. 10 to FIG. 13 show an example of a screen that displays a process of inputting a word composed of two letters via inputting a first-input Chinese character of a first letter of the word, and at least one single-stroke Chinese character or multiple-strokes Chinese character, and an inter-letters spacer, and a first-input Chinese character of a second letter of the target word, when a device for inputting a Chinese word based on a first-input Chinese character according to the present disclosure is embodied as a smart phone.

FIG. 14 to FIG. 17 show an example of a screen that displays a process of inputting a word composed of two letters via inputting a first-input Chinese character of a first letter of the word, and an inter-letters spacer, and a first-input Chinese character of a second letter of the target word and via extending a word-recommending interface, when a device for inputting a Chinese word based on a first-input Chinese character according to the present disclosure is embodied as a smart phone.

FIG. 18 to FIG. 20 show an example of a screen that displays a process of inputting a word composed of three letters via inputting a first-input Chinese character of a first letter of the word, and an inter-letters spacer, and a first-input Chinese character of a second letter of the target word, when a device for inputting a Chinese word based on a first-input Chinese character according to the present disclosure is embodied as a smart phone.

FIG. 21 to FIG. 24 show an example of a screen that displays a process of inputting a word composed of three letters via inputting a first-input Chinese character of a first letter of the word, and an inter-letters spacer, and a first-input Chinese character of a second letter of the target word and via extending a word-recommending interface, when a device for inputting a Chinese word based on a first-input Chinese character according to the present disclosure is embodied as a smart phone.

FIG. 25 to FIG. 28 show an example of a screen that displays a process of inputting a word composed of three letters via inputting a first-input Chinese character of a first letter of the word, and a first inter-letters spacer, and a first-input Chinese character of a second letter of the target word and a second inter-letters spacer, and a first-input Chinese character of a third letter of the word, and via extending a word-recommending interface, when a device for inputting a Chinese word based on a first-input Chinese character according to the present disclosure is embodied as a smart phone.

### DETAILED DESCRIPTIONS

For simplicity and clarity of illustration, elements in the figures are not necessarily drawn to scale. The same reference numbers in different figures denote the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

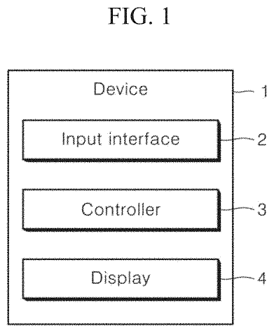

FIG. 1 is a block diagram showing a schematic configuration of a device for inputting a Chinese word based on a first-input Chinese character according to an embodiment of the present disclosure.

Referring to FIG. 1, device 1 for inputting a Chinese word based on a first-input Chinese character according to an embodiment of the present disclosure includes an input interface 2, a controller 3, and a display 4.

The input interface 2 receives at least one single-stroke Chinese character or multiple-strokes Chinese character, a first-input Chinese character of a first letter of a word, and an inter-letters spacer from a user.

As used herein, the single-stroke Chinese character means a Chinese character having a single-stroke. Further, the multiple-strokes Chinese character means a Chinese character having multiple-strokes. The first-input Chinese character means the single-stroke Chinese character or the multiple-strokes Chinese character of a first or second letter of a word and means a topmost member or a topmost and leftmost member of the first or second Chinese letter.

Therefore, a Chinese letter may include at least one single-stroke Chinese character. In accordance with the present disclosure, the user may input a single-stroke Chinese character that may be included in the Chinese letter via the input interface 2. Table 1 below lists single-stroke Chinese characters that the device 1 for inputting a Chinese word based on a first-input Chinese character according to an embodiment of the present disclosure may receive.

TABLE 1

| | | | | | | | | | |
|---|---|---|---|---|---|---|---|---|---|
| 1 | [symbol] | 2 | [symbol] | 3 | [symbol] | 4 | [symbol] | 5 | [symbol] |
| 6 | [symbol] | 7 | [symbol] | 8 | [symbol] | 9 | [symbol] | 10 | [symbol] |
| 11 | [symbol] | 12 | [symbol] | 13 | [symbol] | 14 | [symbol] | 15 | [symbol] |
| 16 | [symbol] | 17 | [symbol] | 18 | [symbol] | 19 | [symbol] | 20 | [symbol] |
| 21 | [symbol] | 22 | [symbol] | 23 | [symbol] | 24 | [symbol] | | |

Table 1 illustrates 24 single-stroke Chinese characters that may be received by the device 1 for inputting Chinese words based on first-input Chinese characters according to one embodiment of the present disclosure. A device 1 for inputting a Chinese word based on a first-input Chinese character according to another embodiment according to the present disclosure may receive only some of the 24 single-stroke Chinese characters included in Table 1 or may receive combinations between some of the 24 single-stroke Chinese characters included in Table 1 and other single-stroke Chinese characters not included in Table 1.

Further, a Chinese letter may include at least one multiple-strokes Chinese character. In accordance with the present disclosure, the user may input a multiple-strokes Chinese character that may be included in the Chinese letter via the input interface 2. Table 2 below lists multiple-strokes Chinese characters that the device 1 for inputting a Chinese word based on a first-input Chinese character according to an embodiment of the present disclosure may receive.

TABLE 2

| | | | | | | | | | |
|---|---|---|---|---|---|---|---|---|---|
| 1 | [symbol] | 2 | [symbol] | 3 | [symbol] | 4 | [symbol] | 5 | [symbol] |
| 6 | [symbol] | 7 | [symbol] | 8 | [symbol] | 9 | [symbol] | 10 | [symbol] |
| 11 | [symbol] | 12 | [symbol] | 13 | [symbol] | 14 | [symbol] | 15 | [symbol] |
| 16 | [symbol] | 17 | [symbol] | 18 | [symbol] | 19 | [symbol] | 20 | [symbol] |
| 21 | [symbol] | 22 | [symbol] | 23 | [symbol] | 24 | [symbol] | 25 | [symbol] |
| 26 | [symbol] | 27 | [symbol] | 28 | [symbol] | | | | |

Table 2 illustrates 28 multiple-strokes Chinese characters that may be received by the device 1 for inputting Chinese words based on first-input Chinese characters according to one embodiment of the present disclosure. A device 1 for inputting a Chinese word based on a first-input Chinese character according to another embodiment according to the present disclosure may receive only some of the 28 multiple-strokes Chinese characters included in Table 2 or may receive combinations between some of the 28 multiple-strokes Chinese characters included in Table 2 and other multiple-strokes Chinese characters not included in Table 2.

Table 3 below lists some of the multiple-strokes Chinese characters that may be received by the device 1 for inputting a Chinese word based on first-input Chinese characters in accordance with the present disclosure, and corresponding letters to the multiple-strokes Chinese characters. Some of the multiple-strokes Chinese characters in accordance with the present disclosure may include Simplified or Traditional Chinese letters. Accordingly, when the user inputs a multiple-strokes Chinese character at a left side of a right cell to a cell corresponding to each number in Table 3 below, the device may input a simplified or traditional character corresponding to the input multiple-strokes Chinese character at a right side of the right cell to a cell corresponding to each number in Table 3 below.

TABLE 3

| | | | | | |
|---|---|---|---|---|---|
| 1 | [symbol] | 2 | [symbol] | 3 | [symbol] |
| 4 | [symbol] | 5 | [symbol] | 6 | [symbol] |
| 7 | [symbol] | 8 | [symbol] | | |

The first-input Chinese character means the single-stroke Chinese character or the multiple-strokes Chinese character of a first or second or third letter of a word and means a topmost member or a topmost and leftmost member of the first or second Chinese letter.

Therefore, when the user inputs the first-input Chinese character of the Chinese letter to the device 1 for inputting the Chinese word based on the first-input Chinese character, the device 1 for inputting the Chinese word based on the first-input Chinese character may select and display a recommended Chinese word including a letter containing the first-input Chinese character.

In accordance with the present disclosure, the inter-letters spacer is configured to space adjacent letters of a word from each other to allow the device to distinguish between the adjacent letters. When the user inputs a word including at least two letters, the inter-letters spacer acts to distinguish between a first-input Chinese character and at least one single-stroke Chinese character or multiple-strokes Chinese character included in a first letter of a target word and a first-input Chinese character and at least one single-stroke Chinese character or multiple-strokes Chinese character included in a second letter of the target word. In other words, the user uses the inter-letters spacer to input a first-input Chinese character and at least one single-stroke Chinese character or multiple-strokes Chinese character included in a first letter of a target word and a first-input Chinese character and at least one single-stroke Chinese character or multiple-strokes Chinese character included in a second letter of the target word in an individual manner. In accordance with the present disclosure, the user may input the inter-letters spacers via the input interface 2.

The controller 3 selects a plurality of recommended Chinese words based on the first-input Chinese character, at least one single-stroke Chinese character, or multiple-strokes Chinese character and inter-letters spacer as received from the user.

In this connection, when the input interface 2 receives the first-input Chinese character from the user, the controller 3 determines recommended Chinese words, each word having a letter that contains the first-input Chinese character received from the user and composed of at least one letter.

The input interface 2 may receive the first-input Chinese character from the user and at least one single-stroke Chinese character or multiple-strokes Chinese character from the user. Thus, when the input interface 2 receives the first-input Chinese character from the user, the controller 3 determines recommended Chinese words, each word having a letter that contains the first-input Chinese character received from the user and composed of at least one letter. When the input interface 2 receives the at least one single-stroke Chinese character or multiple-strokes Chinese character from the user, the controller 3 determines recommended Chinese words, each word having a letter containing the first-input Chinese character received from the user and at least one single-stroke Chinese character or multiple-strokes Chinese character received the user and composed of at least one letter.

Further, when the input interface 2 receives a first-input Chinese character and an inter-letters spacer from the user, the controller 3 determines recommended Chinese words, each word having a letter containing the first-input Chinese character received from the user and composed of two or more letters.

In one embodiment, the input interface 2 receives a first-input Chinese character from the user, at least one single-stroke Chinese character or multiple-strokes Chinese character from the user, and receives an inter-letters spacer from the user. Thus, when the controller 3 receives the first-input Chinese character from the user, the controller 3 determines recommended Chinese words, each word having a letter that contains the first-input Chinese character received from the user and composed of at least one letter. When the controller 3 receives the at least one single-stroke Chinese character or multiple-strokes Chinese character from the user, the controller 3 determines recommended Chinese words, each word having a letter containing the first-input Chinese character received from the user and at least one single-stroke Chinese character or multiple-strokes Chinese character received the user and composed of at least one letter. When the controller 3 receives the inter-letters spacer from the user, the controller 3 determines recommended Chinese words, each word having a letter containing the first-input Chinese character received from the user and at least one single-stroke Chinese character or multiple-strokes Chinese character received the user and composed of at least two letters.

The input interface 2 receives a first-input Chinese character from the user, then receives an inter-letters spacer and then receives a further first-input Chinese character from the user. Thus, when controller 3 first receives the first-input Chinese character from the user, the controller 3 determines recommended Chinese words, each word having a letter containing the first-input Chinese character received from the user and composed of at least one letter. Then, when the controller 3 receives the inter-letters spacer from the user, the controller 3 determines recommended Chinese words, each word having a letter containing the first-input Chinese character received from the user and composed of at least two letters. Then, when the controller 3 receives the further first-input Chinese character from the user, the controller 3 determines recommended Chinese words, each word having a first letter containing the first-input Chinese character received from the user and a second letter containing the further first-input Chinese character received from the user and composed of at least two letters.

The display 4 displays the first-input Chinese character, single-stroke Chinese character, multiple-strokes Chinese character, or inter-letters spacer input by the user on an character-input interface, and displays the recommended Chinese words determined by the controller 3 on a word-recommending interface, and displays a word selected by the user from the recommended Chinese words on a selected-word display interface. In this connection, the display 4 may display the recommended Chinese words on the word-recommending interface immediately upon determining the recommended Chinese words by the controller 3.

In an embodiment according to the present disclosure, the device 1 for inputting a Chinese word based on a first-input Chinese character may be embodied as an electronic device such as a computer or a smart phone. A scheme in which the input interface 2 receives the first-input Chinese character from the user, and the scheme in which the display 4 displays the first-input Chinese character, etc. on the character-input interface, displays the recommended Chinese words on the word-recommending interface, and displays a selected word on the selected-word display interface may vary depending on a type of the electronic device as the device 1 for inputting Chinese words based on the first-input Chinese character.

For example, when the device 1 for inputting a Chinese word based on a first-input Chinese character is embodied as a computer, the input interface 2 may receive the first-input Chinese character, etc. from the user via typing on a keyboard connected to the computer or clicking a mouse connected thereto. In this connection, the display 4 may communicate visual information with the user via an external display device such as a monitor connected to the computer.

In accordance with the present disclosure, the visual information that the display 4 conveys to the user may include all information required for the user to input the Chinese letter. In particular, the visual information may include information about the first-input Chinese character, inter-letters spacer, or word that the display 4 may display on the character-input interface, the word-recommending interface, and the selected-word display interface as described later.

In another embodiment, when the device 1 for inputting a Chinese word based on a first-input Chinese character is embodied as a smartphone, the input interface 2 and display 4 may receive the first-input Chinese character via one touch screen and may convey other visual information to the user respectively. That is, the input interface 2 may receive the first-input Chinese character, etc. from the user via the touch screen and then the display 4 may pass the visual information to the user via the touch screen.

Hereinafter, a case where the device 1 for inputting a Chinese word based on a first-input Chinese character according to the present disclosure is embodied as a smartphone will be set forth by way of example.

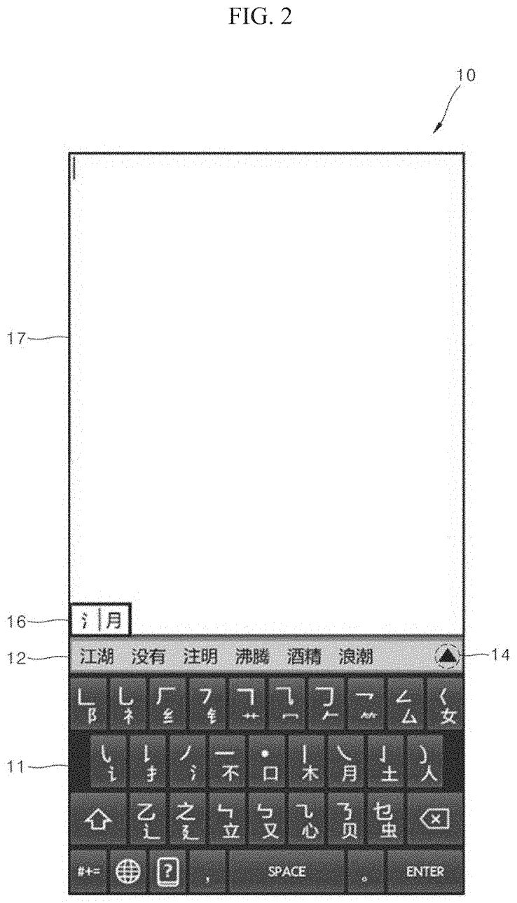

FIG. 2 shows an example of a screen where a word-recommending interface is not extended when a device for inputting a Chinese word based on a first-input Chinese character according to the present disclosure is embodied as a smart phone.

Referring to FIG. 2, a touch screen 10 of a smartphone according to an embodiment of the present disclosure may include a virtual keyboard 11, a word-recommending interface 12, a character-input interface 16 and a selected-word display interface 17. The display 4 defines the virtual keyboard 11 in a bottom portion of the touch screen 10, and defines the word-recommending interface 12 above the virtual keyboard 11. Further, the display 4 may define the character-input interface 16 at a left side of a region above the word-recommending interface 12 on the touch screen 10. The display 4 may define the selected-word display interface 17 in an entirety of a portion of the screen in which the virtual keyboard 11, the word-recommending interface 12, or the character-input interface 16 is not defined.

The user may press the virtual keyboard 11 to input the first-input Chinese character, single-stroke Chinese character, multiple-strokes Chinese character or inter-letters spacer on the input interface 2. The display 4 may display the first-input Chinese characters, single-stroke Chinese characters, multiple-strokes Chinese characters, or inter-letters spacers input by the user on the character-input interface 16, may display the recommended Chinese words determined by the controller 3 on the word-recommending interface 12, and may display the word selected by the user among the three recommended Chinese words on the selected-word display interface 17.

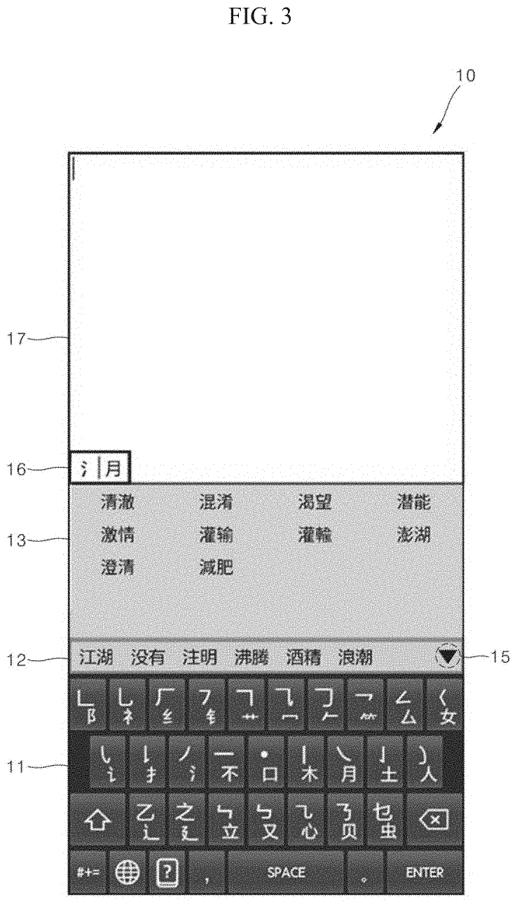

When the recommended Chinese words are displayed on the word-recommending interface 12, an extending button 14 may be disposed at a right end in the word-recommending interface 12. The user may press the extending button 14 to increase the number of recommended Chinese words displayed on the word-recommending interface 12. An extended screen displaying the increased number of the recommended Chinese words displayed on the word-recommending interface 12 may be configured as shown in FIG. 3.

FIG. 3 shows an example of a screen where a word-recommending interface has been extended when a device for inputting a Chinese word based on a first-input Chinese character according to the present disclosure is embodied as a smart phone.

Referring to FIG. 3, when the user presses the extending button 14, the display 4 may display an extended word-recommending interface 13 that includes the increased number of the recommended Chinese words above the word-recommending interface 12 of the touch screen 10. The extended word-recommending interface 13 is included in the word-recommending interface 12. As a result, a size of the selected-word display interface 17 on which the display 4 displays the selected word may be reduced.

The extended word-recommending interface 13 may further display recommended Chinese words determined by the controller 3. The extended word-recommending interface 13 according to an embodiment of the present disclosure may be configured such that the user may scroll along the touch screen 10 to view the increased number of the recommended Chinese words.

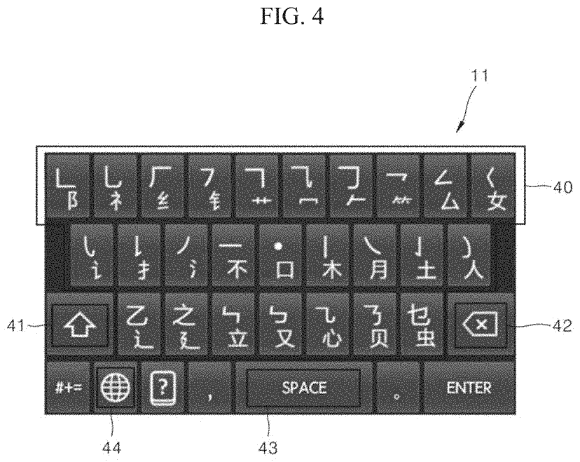

When the extended word-recommending interface 13 is displayed, a reducing button 15 may be disposed in a right end in the word-recommending interface 12. The user may press the reducing button 15 to reduce the number of recommended Chinese words displayed on the word-recommending interface 12. The screen in which the number of recommended Chinese words displayed on the word-recommending interface 12 is reduced may be configured as shown in FIG. 4.

FIG. 4 shows an example of a virtual keyboard having a single-stroke Chinese character button and a multiple-strokes Chinese character button according to the present disclosure.

Referring to FIG. 4, the virtual keyboard 10 according to an embodiment of the present disclosure may include a single-stroke Chinese character and multiple-strokes Chinese character interface 40, a character type conversion button 41, a deletion button 42, an inter-letters spacer button 43, and a mode conversion button 44.

The single-stroke Chinese character and multiple-strokes Chinese character interface 40 may include a plurality of buttons corresponding to single-stroke Chinese characters and multiple-strokes Chinese characters indicated thereon for inputting Chinese letters. All of the single-stroke Chinese characters included in Table 1 and some of the multiple-strokes Chinese characters included in Table 2 may be displayed on top faces of buttons in the single-stroke Chinese characters and multiple-strokes Chinese character interface 40. That is, the user presses a single-stroke Chinese character or multiple-strokes Chinese character button in the single-stroke Chinese character and multiple-strokes Chinese character interface 40 to input a corresponding single-stroke Chinese character or multiple-strokes Chinese character. Thus, some of all single-stroke Chinese characters and multiple-strokes Chinese characters may be input to the device 1 for inputting a Chinese word based on the first-input Chinese character according to the present disclosure.

Further, all of the multiple-strokes Chinese characters not displayed at uppers portions of the buttons in the single-stroke Chinese characters and multiple-strokes Chinese character interface 40 among the multiple-strokes Chinese characters included in Table 2 may be displayed at lower portions of the buttons in the single-stroke Chinese character and multiple-strokes Chinese character interface 40. That is, the user presses each button in the single-stroke Chinese character and multiple-strokes Chinese character interface 40 to input a corresponding multiple-strokes Chinese character displayed at a lower portion of each button. Thus, the multiple-strokes Chinese character may be input to the device 1 for inputting Chinese words based on the first-input Chinese character according to an embodiment of the present disclosure.

In one embodiment according to the present disclosure, the user presses each button in the single-stroke Chinese character and multiple-strokes Chinese character interface 40 for a duration less than a predetermined reference time duration, such that a corresponding single-stroke Chinese character displayed at an upper portion of each button in the single-stroke Chinese character and multiple-strokes Chinese character interface 40 may be input to the device. In one embodiment according to the present disclosure, the user presses each button in the single-stroke Chinese character and multiple-strokes Chinese character interface 40 for a duration greater than or equal to a predetermined reference time duration, such that a corresponding multiple-strokes Chinese character displayed at a lower portion of each button in the single-stroke Chinese character and multiple-strokes Chinese character interface 40 may be input to the device.

In one embodiment according to the present disclosure, the user presses the character type conversion button 41 on the virtual keyboard 11 to switch a character type between a single-stroke Chinese character and a multiple-strokes Chinese character on each button in the single-stroke Chinese characters and multiple-strokes Chinese characters interface 40. Thus, in this connection, when the conversion button 41 is activated, the user presses each button in the single-stroke Chinese character and multiple-strokes Chinese character interface 40 for a duration greater than or equal to a predetermined reference time duration, such that a corresponding single-stroke Chinese character displayed at an upper portion of each button in the single-stroke Chinese character and multiple-strokes Chinese character interface 40 may be input to the device. In one embodiment according to the present disclosure, the user presses each button in the single-stroke Chinese character and multiple-strokes Chinese character interface 40 for a duration smaller than a predetermined reference time duration, such that a corresponding multiple-strokes Chinese character displayed at a lower portion of each button in the single-stroke Chinese character and multiple-strokes Chinese character interface 40 may be input to the device.

In one embodiment according to the present disclosure, the user may press the deletion button 42 to cancel the inputting of the first-input Chinese character, single-stroke Chinese character, multiple-strokes Chinese character, or inter-letters spacer. Further, even when the word is displayed on the selected-word display interface 17 by the user selecting the word on the word-recommending interface 12, the user may cancel the inputting of the word by pressing the deletion button 34.

In one embodiment according to the present disclosure, the user may press the inter-letters spacer button 43 to enter the inter-letters spacer. When the user inputs a word having at least two letters by the user pressing the inter-letters spacer button, the user may include a first-input Chinese character and at least one single-stroke Chinese character or multiple-strokes Chinese character included in a first letter of the word, and a first-input Chinese character and at least one single-stroke Chinese character or multiple-strokes Chinese character included in a second letter of the target word in an individual manner.

In one embodiment according to the present disclosure, the user may press the mode conversion button 44 to allow the virtual keyboard 11 to display thereon a different type of an interface from a type of the single-stroke Chinese character and multiple-strokes Chinese character interface 40. In this connection, the different type of the interface from the type of the single-stroke Chinese character and multiple-strokes Chinese character interface 40 may include an English alphabet input interface, an Korean alphabet input interface, etc. Thus, the user may allow the keyboard 11 to display a different type of an interface via pressing the mode conversion button 44. Thus, the user may input Chinese characters using other Chinese character input methods, for example, a Chinese character Pinyin based input method. In this connection, a Chinese character input screen displayed on the display 4 of the device 1 for inputting Chinese words based on first-input Chinese characters according to the present disclosure may be configured similarly to a Chinese character input screen according to other Chinese character input methods, for example, a Chinese character Pinyin based input method. Further, even when the user uses the other Chinese character input methods, for example, a Chinese character Pinyin based input method, the character-input interface 16 and word-recommending interface 12 may be configured in accordance with the present disclosure. Therefore, when the user inputs several letters formed of Chinese characters, the user may press the mode conversion button 44 to input some letters using the Chinese character input method according to the present disclosure or to input some letters using the other Chinese character input methods, for example, a Chinese character Pinyin based input method. Thus, the Chinese character input method according to the present disclosure may be combined with the other Chinese character input methods, for example, a Chinese character Pinyin based input method.

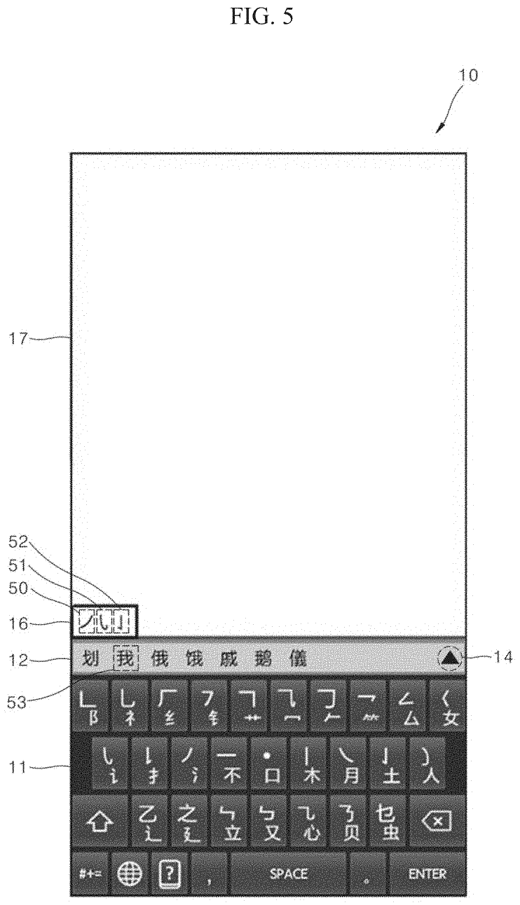

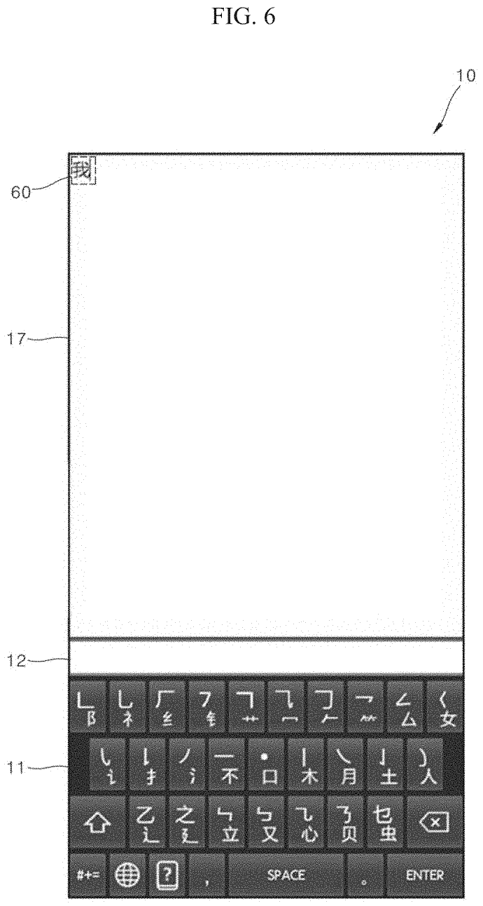

FIG. 5 and FIG. 6 show an example of a screen that displays a process of inputting a word composed of one letter via inputting a first-input Chinese character of a first letter of the word and at least one single-stroke Chinese character or multiple-strokes Chinese character, when a device for inputting a Chinese word based on a first-input Chinese character according to the present disclosure is embodied as a smart phone.

Referring to FIG. 5, the user may enter a first-input Chinese character of a first letter of a target word onto the input interface 2 using the virtual keyboard 11 on the touch screen 10.

Then, the display 4 displays the first-input Chinese character of the first letter of the word entered by the user on the character-input interface 16 on the touch screen 10. FIG. 5 shows a case where the user inputs a first character 50 as the first-input Chinese character of the first letter of the word.

Then, the controller 3 determines recommended Chinese words, each word having a letter that contains the first character 50 as the first-input Chinese character received from the user and composed of at least one letter. In this connection, a letter containing the first character 50 may be a first letter of the recommended Chinese word.

The user may then input at least one single-stroke Chinese character or multiple-strokes Chinese character using the virtual keyboard 11 on the touch screen 10.

Then, the display 4 displays the at least one single-stroke Chinese character or multiple-strokes Chinese character entered by the user on the character-input interface 16 of the touch screen 10. FIG. 5 shows a case where the user enters a second character 51 and a third character 52 as the at least one single-stroke Chinese character or multiple-strokes Chinese character.

Then, the controller 3 determines the recommended Chinese words, each word having the first letter composed of the first character 50 as the first-input Chinese character of the first letter of the word and the second character 51 and third character 52 as the at least one single-stroke Chinese character or multiple-strokes Chinese character, each word being composed of at least one letter. In this connection, each of the recommended Chinese words may not be affected by an input sequence of the second character 51 and third character 52 as the at least one single-stroke Chinese character or multiple-strokes Chinese character. That is, the controller 3 determines the same recommended Chinese words in both of a case when the user inputs the second character 51 and third character 52 in this order and a case when the user inputs the third character 52 and second character 51 in this order. In this connection, a letter including all of the first character 50, second character 51 and third character 52 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12. In this connection, the user may select a first word 53 among the words displayed on the word-recommending interface 12.

Referring to FIG. 6, when the user select the first word 53 from the word-recommending interface 12, the first word 60 is displayed on the selected-word display interface 17. Since the user has selected the word to be input from the recommended Chinese words, the recommended Chinese words displayed on the word-recommending interface 12 are removed. Then, the character-input interface 16 disappears.

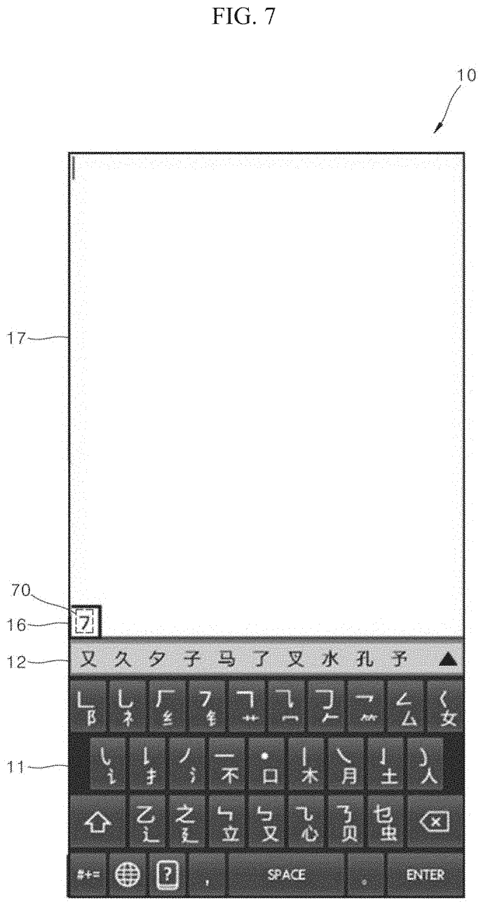

FIG. 7 to FIG. 9 show an example of a screen that displays a process of inputting a word composed of two letters via inputting a first-input Chinese character of a first letter of the word, and an inter-letters spacer, when a device for inputting a Chinese word based on a first-input Chinese character according to the present disclosure is embodied as a smart phone.

Referring to FIG. 7, the user may enter a first-input Chinese character of a first letter of a word into the input interface 2 using the virtual keyboard 11 on the touch screen 10.

Then, the display 4 displays the first-input Chinese character of the first letter of the word entered by the user on the character-input interface 16 on the touch screen 10. FIG. 7 shows a case where the user inputs a fourth character 70 as the first-input Chinese character of the first letter of the word.

Then, the controller 3 determines recommended Chinese words, each word having a letter that contains the fourth character 70 as the first-input Chinese character received from the user and composed of at least one letter. In this connection, a letter containing the fourth character 70 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

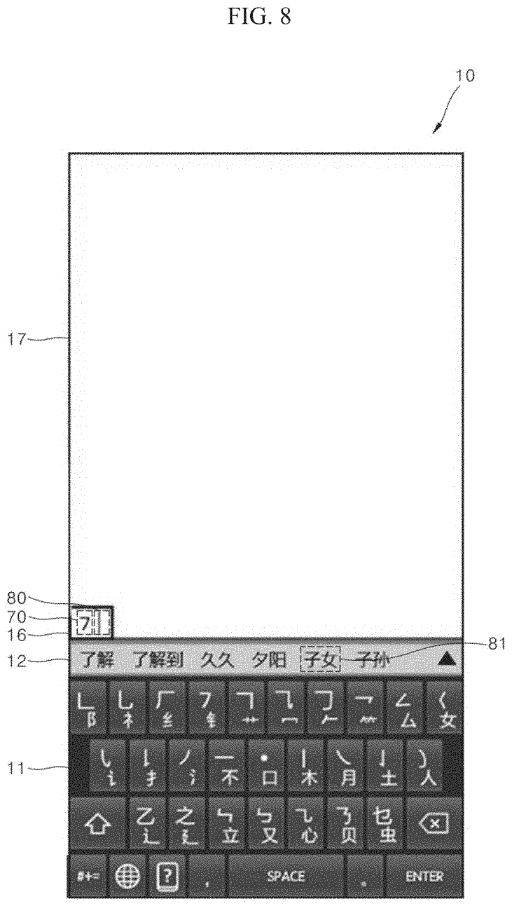

Referring to FIG. 8, the user may input an inter-letters spacer 80 into the input interface 2 using the virtual keyboard 11 on the touch screen 10.

Then, the display 4 displays the fourth character 70 and inter-letters spacer 80 entered by the user on the character-input interface 16 of the touch screen 10.

Then, the controller 3 determines the recommended Chinese words, each word having the first letter containing the fourth character 70 as the first-input Chinese character of the first letter of the word and composed of two or more letters. That is, because the user entered the inter-letters spacer 80, each of the recommended Chinese words is composed of two or more letters. In this connection, the letter including the fourth character 70 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12. In this connection, the user may select a second word 81 displayed on the word-recommending interface 12.

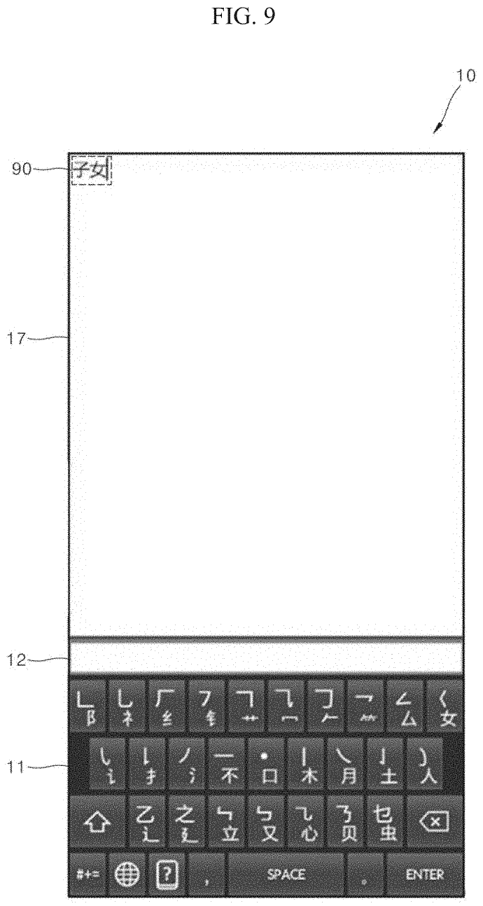

Referring to FIG. 9, when the user select the second word 81 from the word-recommending interface 12, the second word 81 is displayed on the selected-word display interface 17. Since the user has selected the word to be input from the recommended Chinese words, the recommended Chinese words displayed on the word-recommending interface 12 are removed. Then, the character-input interface 16 disappears.

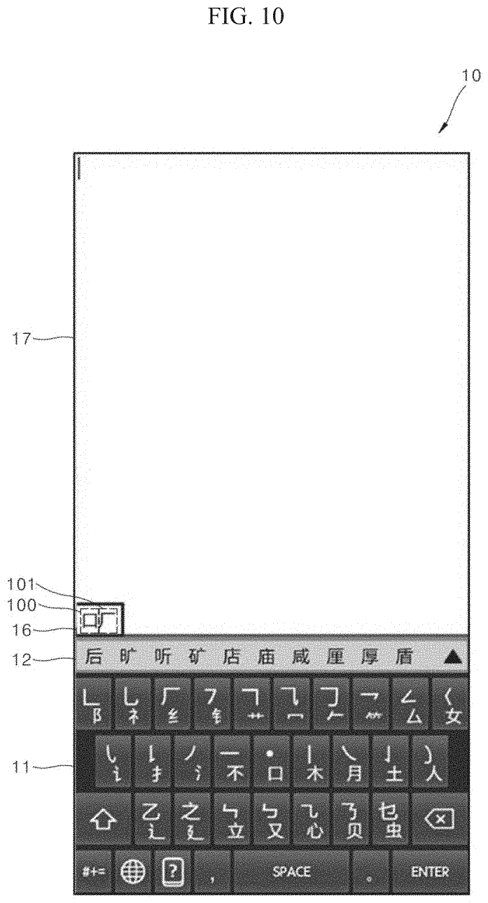

FIG. 10 to FIG. 13 show an example of a screen that displays a process of inputting a word composed of two letters via inputting a first-input Chinese character of a first letter of the word, and at least one single-stroke Chinese character or multiple-strokes Chinese character, and an inter-letters spacer, and a first-input Chinese character of a second letter of the target word, when a device for inputting a Chinese word based on a first-input Chinese character according to the present disclosure is embodied as a smart phone.

Referring to FIG. 10, the user may enter a first-input Chinese character of a first letter of a word into the input interface 2 using the virtual keyboard 11 on the touch screen 10.

Then, the display 4 displays the first-input Chinese character of the first letter of the word entered by the user on the character-input interface 16 on the touch screen 10. FIG. 10 shows a case where the user inputs a fifth character 100 as the first-input Chinese character of the first letter of the word.

Then, the controller 3 determines recommended Chinese words, each word having a letter that contains the fifth character 100 as the first-input Chinese character received from the user and composed of at least one letter. In this connection, a letter containing the fifth character 100 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

The user may then input at least one single-stroke Chinese character or multiple-strokes Chinese character using the virtual keyboard 11 on the touch screen 10.

Then, the display 4 displays the at least one single-stroke Chinese character or multiple-strokes Chinese character entered by the user on the character-input interface 16 of the touch screen 10. FIG. 10 shows a case where the user enters a sixth character 101 as the at least one single-stroke Chinese character or multiple-strokes Chinese character.

Then, the controller 3 determines the recommended Chinese words, each word having the first letter composed of the fifth character 100 as the first-input Chinese character of the first letter of the word and the sixth character 101 as the at least one single-stroke Chinese character or multiple-strokes Chinese character, each word being composed of at least one letter. In this connection, a letter including all of the fifth character 100 and the sixth character 101 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

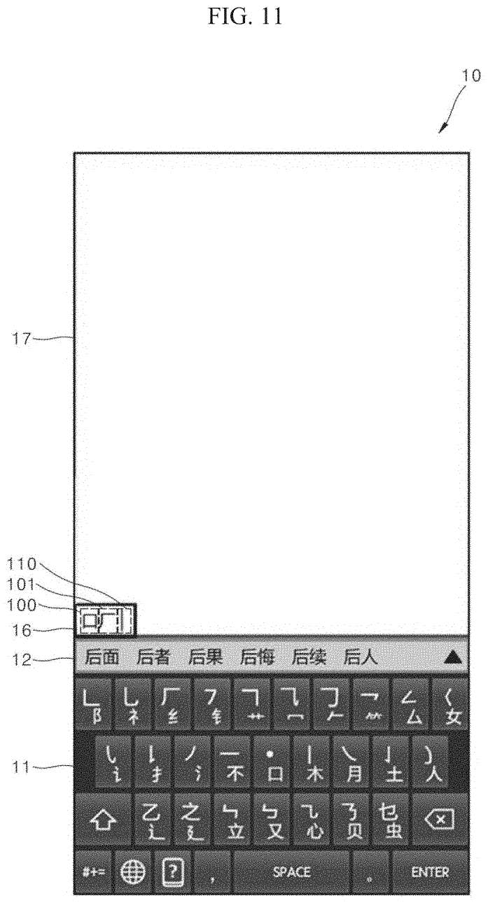

Referring to FIG. 11, the user may input an inter-letters spacer 110 into the input interface 2 using the virtual keyboard 11 on the touch screen 10.

Then, the display 4 displays the fifth character 100, the sixth character 101 and the inter-letters spacer 110 input by the user on the character-input interface 16 of the touch screen 10.

Then, the controller 3 may determine recommended Chinese words, each being composed of two or more letters, and having a letter having the fifth character 100 as the first-input Chinese character of the first letter of the word and the sixth character 101 as the at least one single-stroke Chinese character or multiple-strokes Chinese character. A fact that the user entered the inter-letters spacer 110 may indicate that the user intends to enter a word composed of two or more letters. Thus, the controller 3 may determine recommended Chinese words, each being composed of two or more letters, and having a letter having the fifth character 100 as the first-input Chinese character of the first letter of the word and the sixth character 101 as the at least one single-stroke Chinese character or multiple-strokes Chinese character. In this connection, the letter including the fifth character 100 and the sixth character 101 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

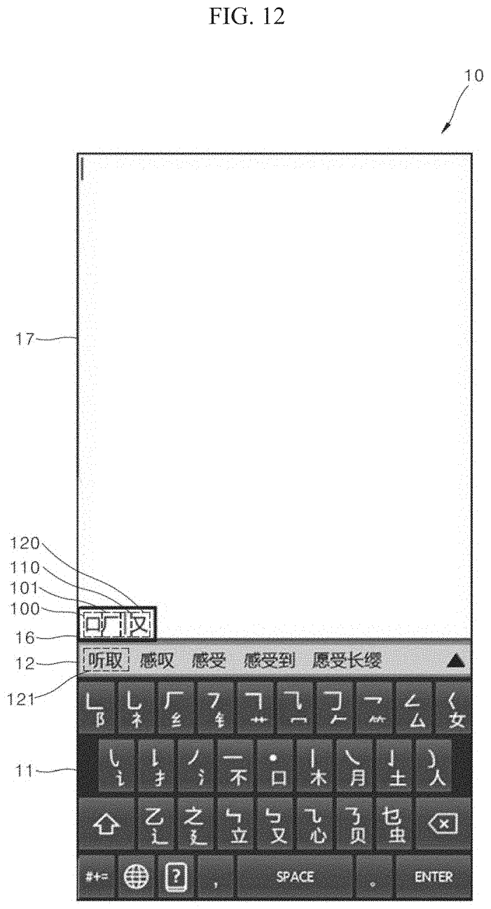

Referring to FIG. 12, the user may enter a first-input Chinese character of a second letter of the target word into the input interface 2 using the virtual keyboard 11 on the touch screen 10.

Then, the display 4 displays the fifth character 100, the sixth character 101, the inter-letters spacer 110, and the first-input Chinese character of a second letter of the target word as entered by the user on the character-input interface 16 of the touch screen 10. FIG. 12 shows a case where the user enters a seventh character 120 as the first-input Chinese character of the second letter of the target word.

Then, the controller 3 determines recommended Chinese words, each word composed of at least two letters, and having a first letter that includes the fifth character 100 as the first-input Chinese character of the first letter of the target word and the sixth character 101 as the at least one single-stroke Chinese character or multiple-strokes Chinese character, and a second letter that includes the seventh character 120 as the first-input Chinese character of the second letter of the word. In this connection, the letter including the fifth character 100 and the sixth character 101 may be the first letter of the recommended Chinese word, while the letter including the seventh character 120 may be the second letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12. In this connection, the user may select a third word 121 among the words displayed on the word-recommending interface 12.

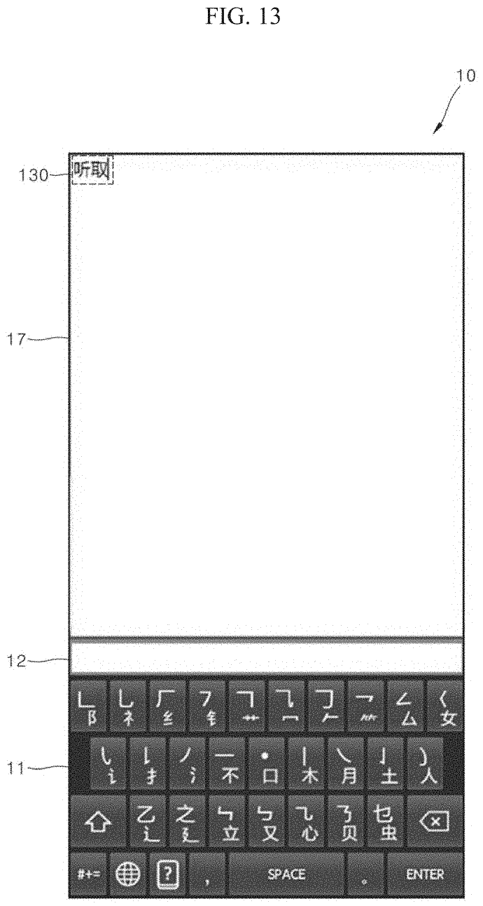

Referring to FIG. 13, when the user select the third word 121 from the word-recommending interface 12, the third word 130 is displayed on the selected-word display interface 17. Since the user has selected the word to be input from the recommended Chinese words, the recommended Chinese words displayed on the word-recommending interface 12 are removed. Then, the character-input interface 16 disappears.

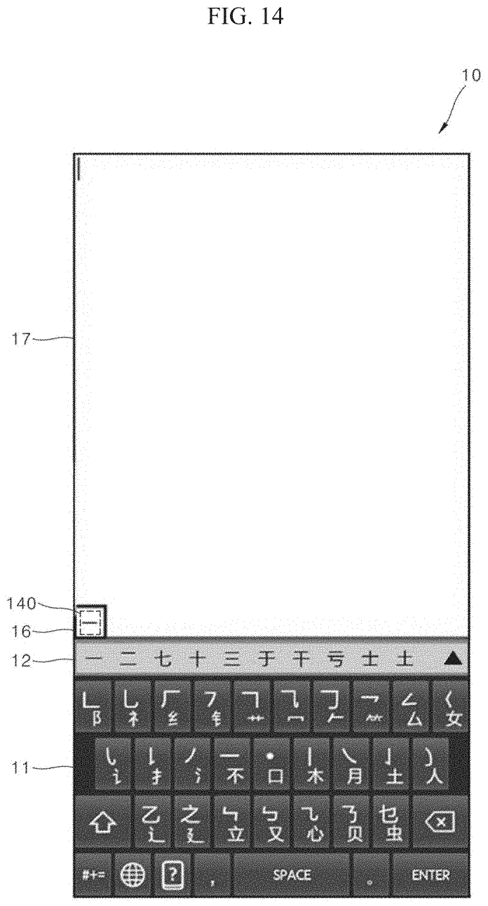

FIG. 14 to FIG. 17 show an example of a screen that displays a process of inputting a word composed of two letters via inputting a first-input Chinese character of a first letter of the word, and an inter-letters spacer, and a first-input Chinese character of a second letter of the target word and via extending a word-recommending interface, when a device for inputting a Chinese word based on a first-input Chinese character according to the present disclosure is embodied as a smart phone.

Referring to FIG. 14, the user may enter a first-input Chinese character of a first letter of a word into the input interface 2 using the virtual keyboard 11 on the touch screen 10.

Then, the display 4 displays the first-input Chinese character of the first letter of the word entered by the user on the character-input interface 16 on the touch screen 10. FIG. 14 shows a case where the user inputs an eighth character 140 as the first-input Chinese character of the first letter of the word.

Then, the controller 3 determines recommended Chinese words, each word having a letter that contains the eighth character 140 as the first-input Chinese character received from the user and composed of at least one letter. In this connection, a letter containing the eighth character 140 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

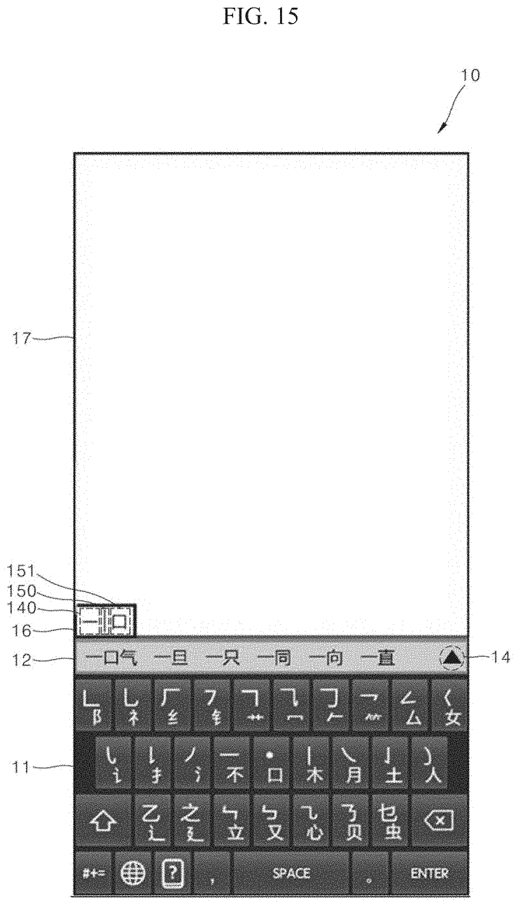

Referring to FIG. 15, the user may input an inter-letters spacer 150 and then may enter a first-input Chinese character of a second letter of the target word into the input interface 2 using the virtual keyboard 11 on the touch screen 10.

Then, the display 4 displays the eighth character 140, the inter-letters spacer 150, and the first-input Chinese character of the second letter of the target word as entered by the user on the character-input interface 16 of the touch screen 10. FIG. 15 shows a case where the user enters a ninth character 151 as the first-input Chinese character of the second letter of the target word.

Then, the controller 3 determines recommended Chinese words, each word composed of at least two letters, and having a first letter that includes the eighth character 140 as the first-input Chinese character of the first letter of the target word, and a second letter that includes the ninth character 151 as the first-input Chinese character of the second letter of the word. In this connection, the letter including the eighth character 140 may be the first letter of the recommended Chinese word, while the letter including the ninth character 151 may be the second letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

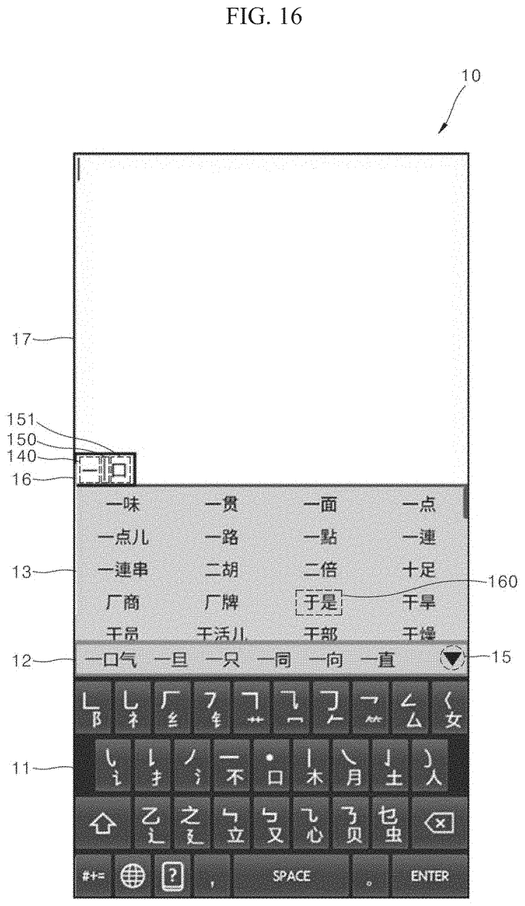

Referring to FIG. 16, among the words as displayed on the word-recommending interface 12, a target word that the user intends to input is not present. Thus, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. In this connection, the user may select a fourth word 160 displayed on the word-recommending interface 12.

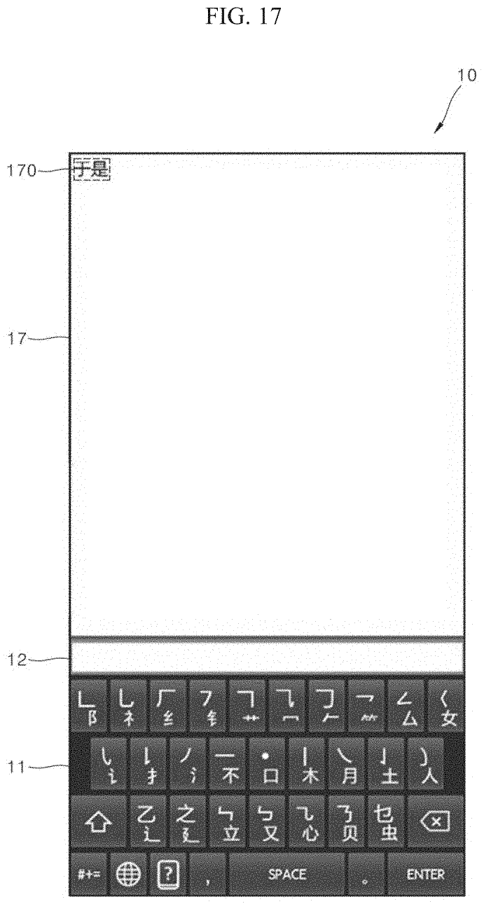

Referring to FIG. 17, when the user select the fourth word 160 from the word-recommending interface 12, the fourth word 170 is displayed on the selected-word display interface 17. Since the user has selected the word to be input from the recommended Chinese words, the recommended Chinese words displayed on the word-recommending interface 12 are removed. Then, the character-input interface 16 disappears.

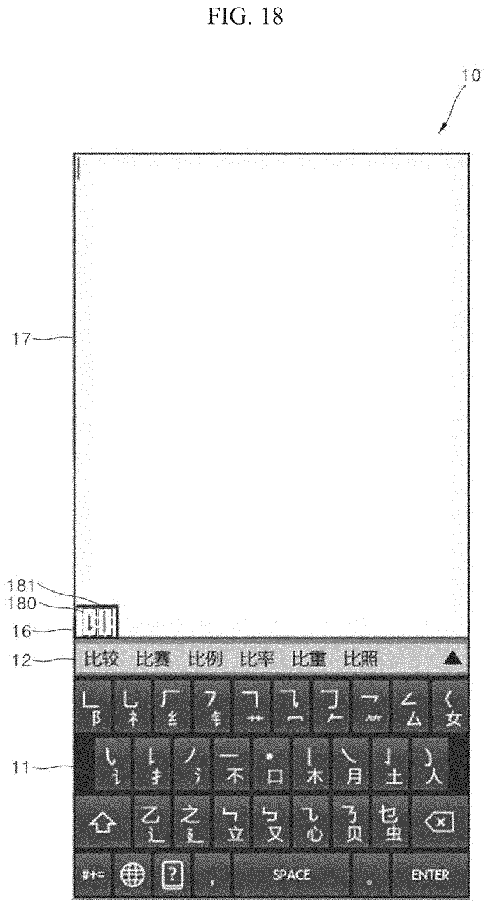

FIG. 18 to FIG. 20 show an example of a screen that displays a process of inputting a word composed of three letters via inputting a first-input Chinese character of a first letter of the word, and an inter-letters spacer, and a first-input Chinese character of a second letter of the target word, when a device for inputting a Chinese word based on a first-input Chinese character according to the present disclosure is embodied as a smart phone.

Referring to FIG. 18, the user may enter a first-input Chinese character of a first letter of a word into the input interface 2 using the virtual keyboard 11 on the touch screen 10 and then an inter-letters spacer 181 into the input interface 2.

Then, the display 4 displays the first-input Chinese character of the first letter of the word and the inter-letters spacer 181 as entered by the user on the character-input interface 16 on the touch screen 10. FIG. 18 shows a case where the user inputs a tenth character 180 as the first-input Chinese character of the first letter of the word.

Then, the controller 3 may determine recommended Chinese words, each being composed of two or more letters, and having a letter having the tenth character 180 as the first-input Chinese character of the first letter of the word. A fact that the user entered the inter-letters spacer 181 may indicate that the user intends to enter a word composed of two or more letters. Thus, the controller 3 may determine recommended Chinese words, each being composed of two or more letters, and having a letter having the tenth character 180 as the first-input Chinese character of the first letter of the word. In this connection, the letter including the tenth character 180 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

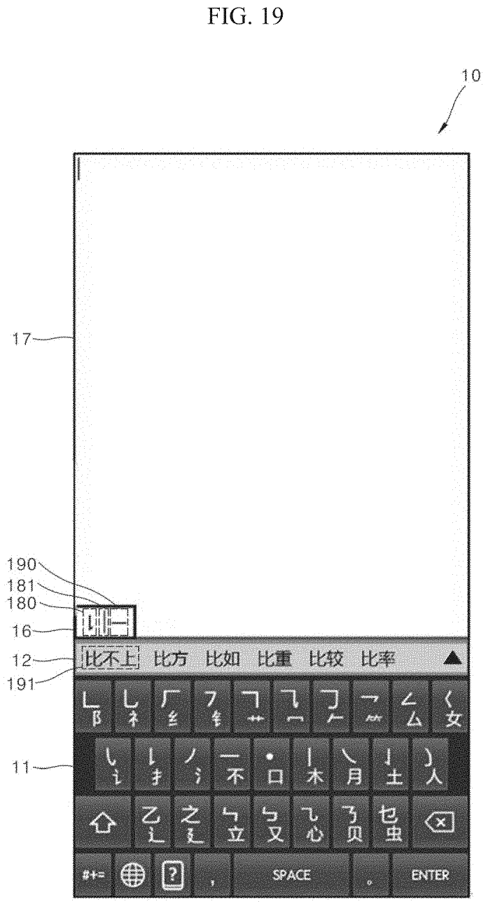

Referring to FIG. 19, the user may input a first-input Chinese character of a second letter of the target word into the input interface 2 using the virtual keyboard 11 on the touch screen 10.

Then, the display 4 displays the tenth character 180, the inter-letters spacer 181, and the first-input Chinese character of the second letter of the target word as entered by the user on the character-input interface 16 of the touch screen 10. FIG. 19 shows a case where the user enters an 11-th character 190 as the first-input Chinese character of the second letter of the target word.

Then, the controller 3 determines recommended Chinese words, each word composed of at least two letters, and having a first letter that includes the tenth character 180 as the first-input Chinese character of the first letter of the target word, and a second letter that includes the eleventh character 190 as the first-input Chinese character of the second letter of the word. In this connection, the letter including the tenth character 180 may be the first letter of the recommended Chinese word, while the letter including the eleventh character 190 may be the second letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

In this connection, the user may select a fifth word 191 among the words displayed on the word-recommending interface 12. The fifth word 191 has three letters. Nevertheless, when the fifth word 191 is determined to be a recommended Chinese word by the controller 3, the fifth word 191 composed of three letters may be quickly obtained while the user does not input a first-input Chinese character of a third letter of the word.

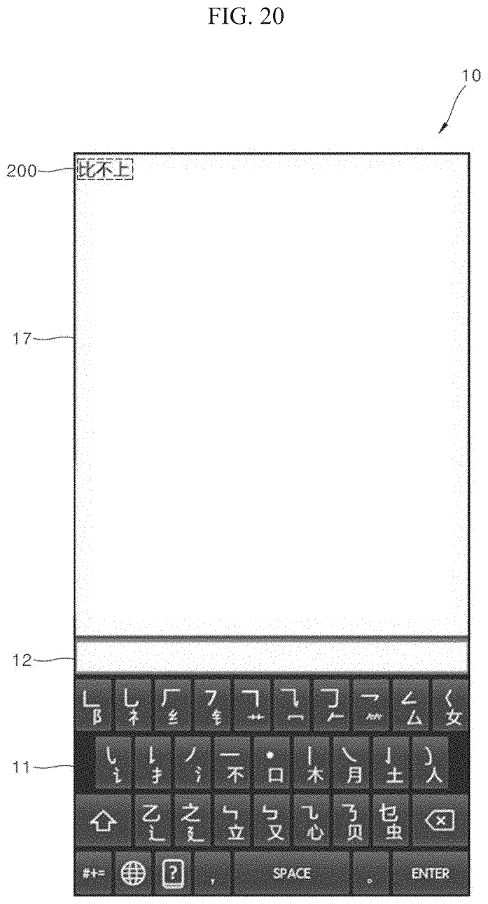

Referring to FIG. 20, when the user select the fifth word 191 from the word-recommending interface 12, the fifth word 200 is displayed on the selected-word display interface 17. Since the user has selected the word to be input from the recommended Chinese words, the recommended Chinese words displayed on the word-recommending interface 12 are removed. Then, the character-input interface 16 disappears.

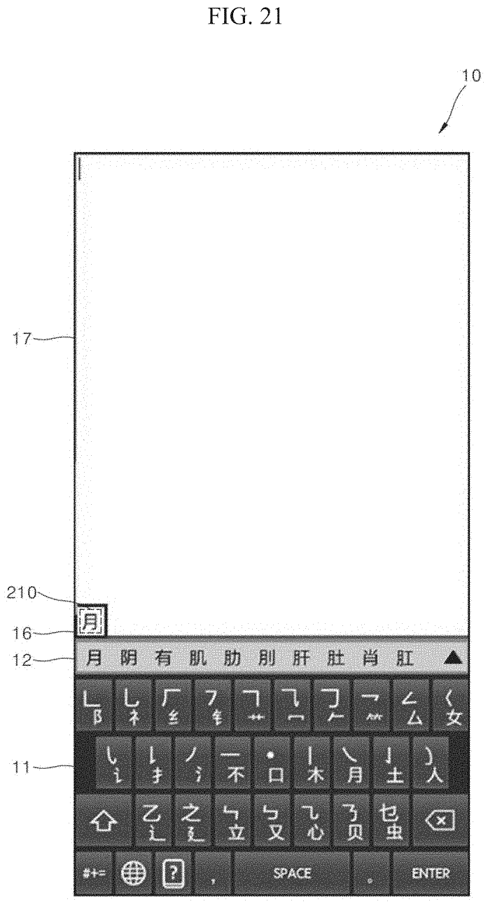

FIG. 21 to FIG. 24 show an example of a screen that displays a process of inputting a word composed of three letters via inputting a first-input Chinese character of a first letter of the word, and an inter-letters spacer, and a first-input Chinese character of a second letter of the target word and via extending a word-recommending interface, when a device for inputting a Chinese word based on a first-input Chinese character according to the present disclosure is embodied as a smart phone.

Referring to FIG. 21, the user may enter a first-input Chinese character of a first letter of a word into the input interface 2 using the virtual keyboard 11 on the touch screen 10.

Then, the display 4 displays the first-input Chinese character of the first letter of the word as entered by the user on the character-input interface 16 on the touch screen 10. FIG. 21 shows a case where the user inputs a 12-th character 210 as the first-input Chinese character of the first letter of the word.

Then, the controller 3 may determine recommended Chinese words, each being composed of at least one letter, and having a letter having the 12-th character 210 as the first-input Chinese character of the first letter of the word. In this connection, the letter including the 12-th character 210 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

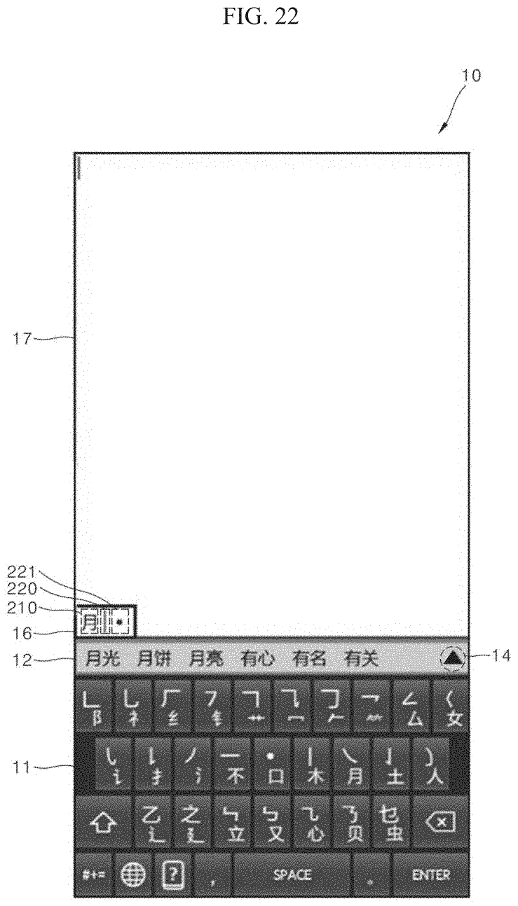

Referring to FIG. 22, the user may input an inter-letters spacer 220 and then a first-input Chinese character of a second letter of the target word into the input interface 2 using the virtual keyboard 11 on the touch screen 10.

Then, the display 4 displays the 12-th character 210, the inter-letters spacer 220, and the first-input Chinese character of the second letter of the target word as entered by the user on the character-input interface 16 of the touch screen 10. FIG. 22 shows a case where the user enters an 13-th character 221 as the first-input Chinese character of the second letter of the target word.

Then, the controller 3 determines recommended Chinese words, each word composed of at least two letters, and having a first letter that includes the 12-th character 210 as the first-input Chinese character of the first letter of the target word, and a second letter that includes the 13-th character 221 as the first-input Chinese character of the second letter of the word. In this connection, the letter including the 12-th character 210 may be the first letter of the recommended Chinese word, while the letter including the 13-th character 221 may be the second letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

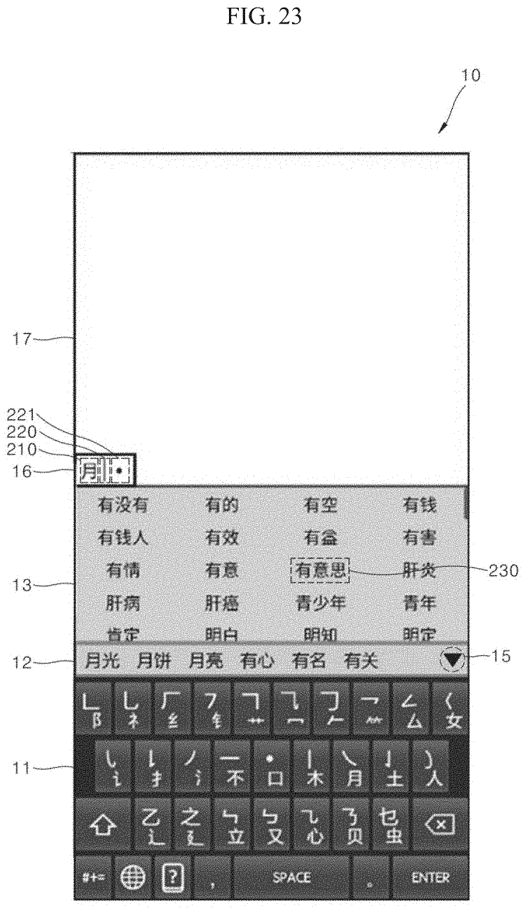

Referring to FIG. 23, among the words as displayed on the word-recommending interface 12, a target word that the user intends to input is not present. Thus, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. In this connection, the user may select a sixth word 230 displayed on the word-recommending interface 12. The sixth word 230 is compose of 3 letters. Nevertheless, when the extended word-recommending interface 13 is displayed using the extending button 14, and the sixth word 230 is determined to be a recommended Chinese word by the controller 3, the sixth word 230 composed of three letters may be quickly obtained while the user does not input a first-input Chinese character of a third letter of the word.

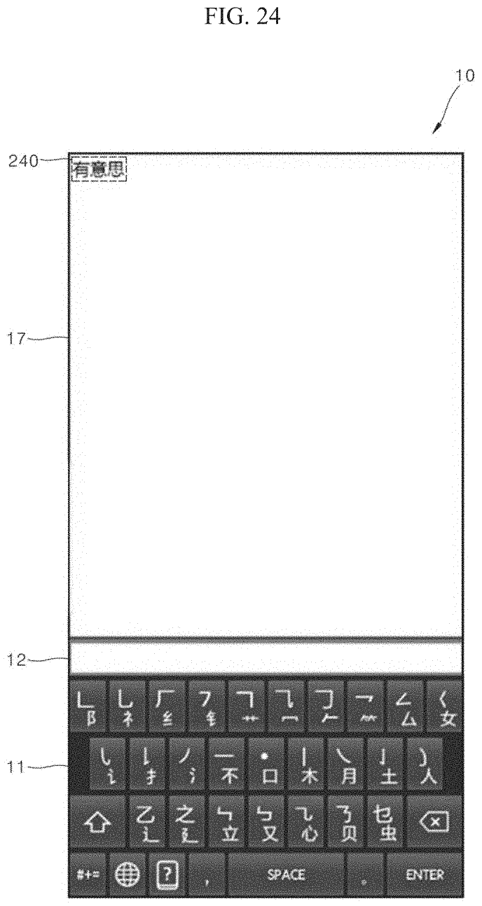

Referring to FIG. 24, when the user select the sixth word 230 from the word-recommending interface 12, the sixth word 240 is displayed on the selected-word display interface 17. Since the user has selected the word to be input from the recommended Chinese words, the recommended Chinese words displayed on the word-recommending interface 12 are removed. Then, the character-input interface 16 disappears.

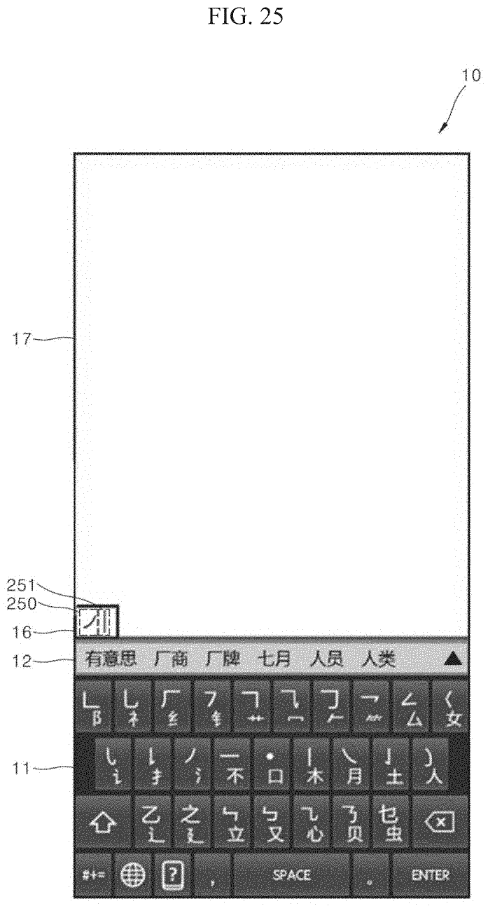

FIG. 25 to FIG. 28 show an example of a screen that displays a process of inputting a word composed of three letters via inputting a first-input Chinese character of a first letter of the word, and a first inter-letters spacer, and a first-input Chinese character of a second letter of the target word and a second inter-letters spacer, and a first-input Chinese character of a third letter of the word, and via extending a word-recommending interface, when a device for inputting a Chinese word based on a first-input Chinese character according to the present disclosure is embodied as a smart phone.

Referring to FIG. 25, the user may enter a first-input Chinese character of a first letter of a word and an inter-letters spacer 251 into the input interface 2 using the virtual keyboard 11 on the touch screen 10.

Then, the display 4 displays the first-input Chinese character of the first letter of the word and the inter-letters spacer 251 as entered by the user on the character-input interface 16 on the touch screen 10. FIG. 21 shows a case where the user inputs a 14-th character 250 as the first-input Chinese character of the first letter of the word.

Then, the controller 3 may determine recommended Chinese words, each being composed of at least two letters, and having a letter having the 14-th character 250 as the first-input Chinese character of the first letter of the word. A fact that the user entered the inter-letters spacer 251 may indicate that the user intends to enter a word composed of two or more letters. Thus, the controller 3 may determine recommended Chinese words, each being composed of two or more letters, and having a letter having the 14-th character 250 as the first-input Chinese character of the first letter of the word. In this connection, the letter including the 14-th character 250 may be a first letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

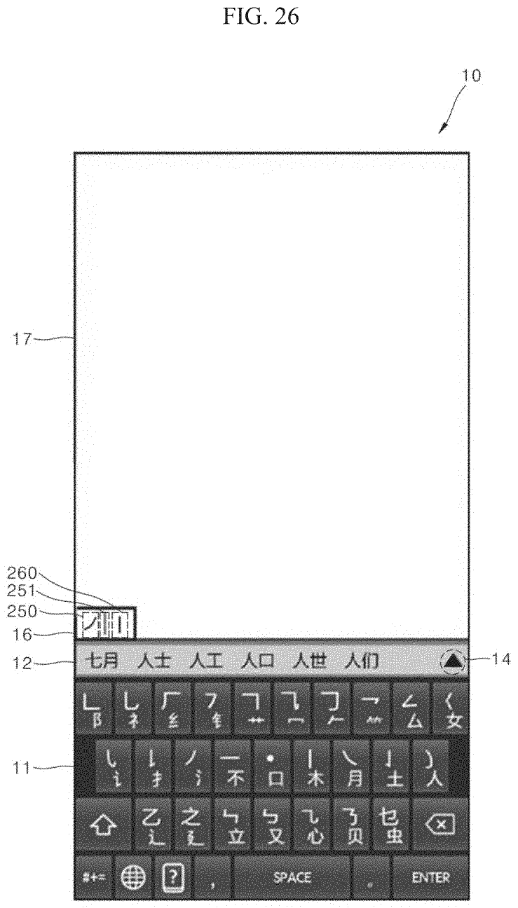

Referring to FIG. 26, the user may input a first-input Chinese character of a second letter of the target word into the input interface 2 using the virtual keyboard 11 on the touch screen 10.

Then, the display 4 displays the 14-th character 250, the inter-letters spacer 251, and the first-input Chinese character of the second letter of the target word as entered by the user on the character-input interface 16 of the touch screen 10. FIG. 26 shows a case where the user enters an 15-th character 260 as the first-input Chinese character of the second letter of the target word.

Then, the controller 3 determines recommended Chinese words, each word composed of at least two letters, and having a first letter that includes the 14-th character 250 as the first-input Chinese character of the first letter of the target word, and a second letter that includes the 15-th character 260 as the first-input Chinese character of the second letter of the word. In this connection, the letter including the 14-th character 250 may be the first letter of the recommended Chinese word, while the letter including the 15-th character 260 may be the second letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12.

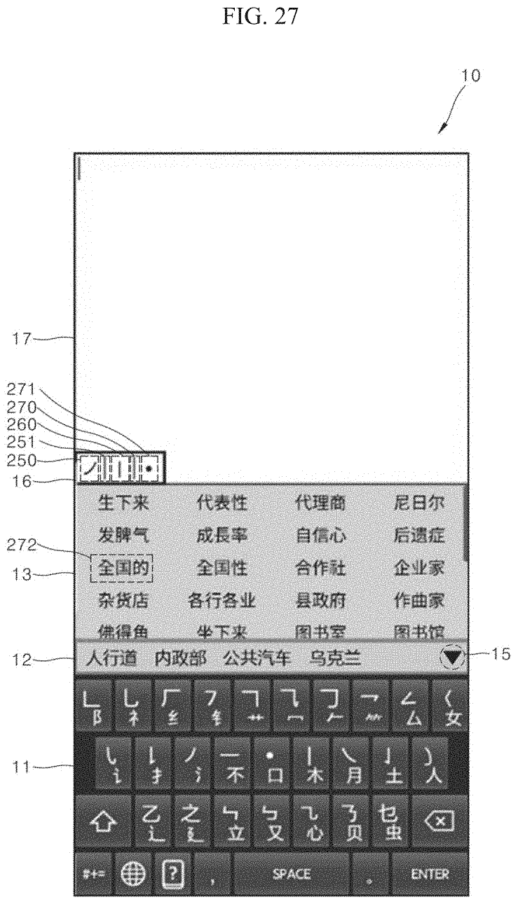

Referring to FIG. 27, the user may input a further inter-letters spacer 270 and a first-input Chinese character of a third letter of the target word into the input interface 2 using the virtual keyboard 11 on the touch screen 10.

Then, the display 4 displays the 14-th character 250, the inter-letters spacer 251, the 15-th character 260, the further inter-letters spacer 270, and the first-input Chinese character of the third letter of the target word as entered by the user on the character-input interface 16 of the touch screen 10. FIG. 27 shows a case where the user enters an 16-th character 271 as the first-input Chinese character of the third letter of the target word.

Then, the controller 3 determines recommended Chinese words, each word composed of at least three letters, and having a first letter that includes the 14-th character 250 as the first-input Chinese character of the first letter of the target word, and a second letter that includes the 15-th character 260 as the first-input Chinese character of the second letter of the word, and a third letter that includes the 16-th character 271 as the first-input Chinese character of the third letter of the word. In this connection, the letter including the 14-th character 250 may be the first letter of the recommended Chinese word, while the letter including the 15-th character 260 may be the second letter of the recommended Chinese word, while the letter including the 16-th character 271 may be the third letter of the recommended Chinese word.

The display 4 then displays at least some of the recommended Chinese words determined by the controller 3 on the word-recommending interface 12 on the touch screen 10. Then, if, among the words as displayed on the word-recommending interface 12, a target word that the user intends to input is present, the user may click on and select the word. If, among the words as displayed on the word-recommending interface 12, a target word that the user intends to input is not present, the user may press the extending button 14 to cause the display 4 to display the word-recommending interface 12 including the extended word-recommending interface 13 on the touch screen 10. That is, the user may press the extending button 14 to increase the number of recommended Chinese words displayed on the word-recommending interface 12. Further, when the extended word-recommending interface 13 is displayed, the user may press the reducing button 15 to reduce the number of recommended Chinese words displayed on the word-recommending interface 12. In this connection, the user may select a seventh word 272 displayed on the word-recommending interface 12.

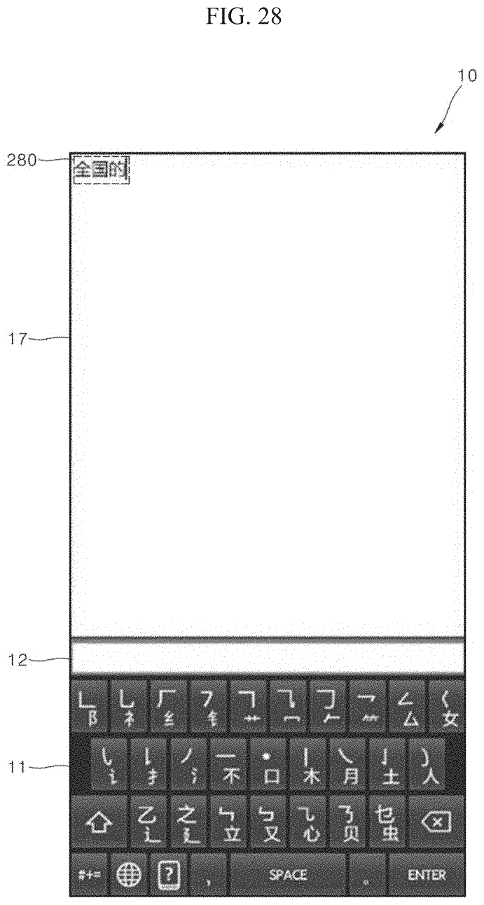

Referring to FIG. 28, when the user select the seventh word 272 from the word-recommending interface 12, the seventh word 280 is displayed on the selected-word display interface 17. Since the user has selected the word to be input from the recommended Chinese words, the recommended Chinese words displayed on the word-recommending interface 12 are removed. Then, the character-input interface 16 disappears.

When using the device and its control method for inputting Chinese words based on the first-input Chinese characters, the user may enter the Chinese letter via inputting of the first-input Chinese character rather than the English alphabet. Thus, the user may input the Chinese letter quickly using the recommended Chinese word as determined based on the first-input Chinese character inputted to the device for inputting the Chinese word based on the first-input Chinese character. Further, the user may quickly enter the Chinese word composed of several letters via inputting of the first-input Chinese character and inter-letters spacer.

Although the present disclosure has been described with reference to the embodiments and drawings as exemplified above, the present disclosure is not limited to the embodiments and drawings disclosed herein. It is obvious that various modifications may be made by a person skilled in the art within the scope of the technical idea according to the present disclosure. In addition, it should be appreciated that effects to be achieved from configurations of the present disclosure as not expressly mentioned may be acknowledged.

What is claimed is:

1. A method for inputting a Chinese word based on a first-input Chinese character, the method comprising:
receiving a first-input Chinese character of a first letter of a target word from a user;
displaying at least some of recommended Chinese words on a word-recommending interface of a device, wherein each recommended Chinese word is composed of at least one letter and has a letter including the first-input Chinese character; and
displaying a Chinese word selected from the recommended Chinese words by the user on a selected-word display interface of the device.

2. The method of claim 1, wherein the method further comprises:
receiving at least one single-stroke Chinese character or multiple-strokes Chinese character from the user after receiving the first-input Chinese character; and
displaying at least some of recommended Chinese words on the word-recommending interface of a device, wherein each recommended Chinese word is composed of at least one letter and has a letter including the first-input Chinese character and the at least one single-stroke Chinese character or multiple-strokes Chinese character.

3. The method of claim 1, wherein the method further comprises:
receiving an inter-letters spacer from the user after receiving the first-input Chinese character; and
displaying at least some of recommended Chinese words on the word-recommending interface, wherein each recommended Chinese word is composed of at least two letters and has a letter including the first-input Chinese character.

4. The method of claim 3, wherein the method further comprises:
receiving a first-input Chinese character of a second letter of the target word from the user after receiving the inter-letters spacer; and
displaying at least some of recommended Chinese words on the word-recommending interface, wherein each recommended Chinese word is composed of at least two letters and has a letter including the first-input Chinese character of the first letter and the first-input Chinese character of the second letter.

5. The method of claim 1, wherein the first-input Chinese character includes:
a single-stroke Chinese character as a topmost member or a topmost and leftmost member of the first letter of the target word; or
one of all of multiple-strokes Chinese characters of the first letter of the target word.

6. The method of claim 2, wherein the at least one single-stroke Chinese character or multiple-strokes Chinese character includes at least two single-stroke Chinese character or multiple-strokes Chinese charters, wherein each of the recommended Chinese words has the at least two single-stroke Chinese character or multiple-strokes Chinese charters, wherein the recommended Chinese words are independent from a receiving sequence of the at least two single-stroke Chinese character or multiple-strokes Chinese charters.

7. The method of claim 1, wherein the method further comprises:
activating an extending button of the device while the at least some of the recommended Chinese words are displayed on the word-recommending interface, such that a number of the recommended Chinese words displayed on the word-recommending interface is increased; or
activating a reducing button of the device while the at least some of the recommended Chinese words are displayed on the word-recommending interface, such that a number of the recommended Chinese words displayed on the word-recommending interface is decreased.

8. A device for inputting a Chinese word based on a first-input Chinese character, the device comprising:
an input interface configured to receive a first-input Chinese character of a first letter of a target word from a user;
a controller configured to determine recommended Chinese words based on the first-input Chinese character such that each recommended Chinese word is composed of at least one letter and has a letter including the first-input Chinese character; and
a display configured to display at least some of the recommended Chinese words on a word-recommending interface and to display a Chinese word selected from the recommended Chinese words by the user on a selected-word display interface.

9. The device of claim 8, wherein the input interface is further configured to receive at least one single-stroke Chinese character or multiple-strokes Chinese character from the user after receiving the first-input Chinese character,
wherein the controller is further configured to determine the recommended Chinese words such that each recommended Chinese word is composed of at least one letter and has a letter including the first-input Chinese character and the at least one single-stroke Chinese character or multiple-strokes Chinese character,
wherein the display is further configured to display at least some of the recommended Chinese words on the word-recommending interface.

10. The device of claim 8, wherein the input interface is further configured to receive an inter-letters spacer from the user after receiving the first-input Chinese character,
wherein the controller is further configured to determine the recommended Chinese words such that each recommended Chinese word is composed of at least two letters and has a letter including the first-input Chinese character,
wherein the display is further configured to display at least some of the recommended Chinese words on the word-recommending interface.

11. The device of claim 10, wherein the input interface is further configured to receive a first-input Chinese character of a second letter of the target word from the user after receiving the inter-letters spacer,
wherein the controller is further configured to determine the recommended Chinese words such that each recommended Chinese word is composed of at least two letters and has a letter including the first-input Chinese character of the first letter and the first-input Chinese character of the second letter,
wherein the display is further configured to display at least some of the recommended Chinese words on the word-recommending interface.

12. The device of claim 8, wherein the first-input Chinese character includes:
a single-stroke Chinese character as a topmost member or a topmost and leftmost member of the first letter of the target word; or
one of all of multiple-strokes Chinese characters of the first letter of the target word.

13. The device of claim 9, wherein the at least one single-stroke Chinese character or multiple-strokes Chinese character includes at least two single-stroke Chinese character or multiple-strokes Chinese charters, wherein each of the recommended Chinese words has the at least two single-stroke Chinese character or multiple-strokes Chinese charters,
wherein the controller is further configured to determine the recommended Chinese words in an independent from a receiving sequence of the at least two single-stroke Chinese character or multiple-strokes Chinese charters.

14. The device of claim 8, wherein the controller is further configured to:
activate an extending button of the device while the at least some of the recommended Chinese words are displayed on the word-recommending interface, such that a number of the recommended Chinese words displayed on the word-recommending interface is increased; or
activate a reducing button of the device while the at least some of the recommended Chinese words are displayed on the word-recommending interface, such that a number of the recommended Chinese words displayed on the word-recommending interface is decreased.
